(19) United States
(12) Patent Application Publication
(10) Pub. No.: US 2004/0147359 A1
(43) Pub. Date: Jul. 29, 2004

(54) Constant mesh clutch

(76) Inventor: Wai Hung Ip, North Point (HK)

Correspondence Address: MERCHANT & GOULD PC, P.O. BOX 2903, MINNEAPOLIS, MN, 55402-0903, US

(21) Appl. No.: 10/390,949

(22) Filed: Mar. 17, 2003

(30) Foreign Application Priority Data
Jan. 24, 2003 (CN) 03 1 03404.7

(51) Int. Cl. F16H 3/44

(52) U.S. Cl. 475/293

(57) ABSTRACT

The present invention relates to a constant mesh clutch for transmission of rotational movement between an input and an output, comprising a first sun gear and a second sun gear, a number of planet gears in mesh with said sun gears and held in a carrier, wherein said carrier has a disc formed integral with it and extending radially for a caliper fixed on the flywheel house to apply a braking force upon it; and said second sun gear has a shaft formed integral with it and serving to carry said first sun gear. As a different braking force is applied on said disc, the power transmitted from said first sun gear through said planet gears to said second sun gear also changes, thus realizing a stepless transmission of power between an input and an output. The constant mesh clutch of the present invention is not only simple in structure and easy to maintain, but also has a high efficiency.

### BACKGROUND OF THE INVENTION

1. Field of the Invention

The present invention relates to a transmission device for use in the automobile industry, particularly, a transmission in the form of constant mesh clutch.

2. Description of the Prior Art

Automobile transmission devices normally fall into two kinds, namely, automatic transmission and manual transmission. Despite continued improvements, automatic transmission is still not so efficient as manual transmission. Because automatic transmission uses torque converters which, despite today's techniques, are still likely to produce slippage during operation. On the other hand, although traditional clutches of manual transmission are more efficient, they almost unexceptionally use a friction plate, which is subject to wear; and to replace it, removal of the whole gearbox is necessary, or even the system has to be suspended, thus being very time-consuming; moreover, adjustment after replacement of parts is necessary. U.S. 2002/0037785 A1 discloses a planetary gear for use in a hand-held power screw-driving tool. A comparison shows that in that U.S. application the planetary gear has a ring gear which transmits the power from the sun gear to the planet gear carrier, whereby the rotation speed of the planet gears is different from that of the sun gear. In the constant mesh clutch of the present invention, there is no ring gear, and power transmission is between two sun gears, whereby no change in rotation speed occurs.

U.S. Pat. No. 5,851,163 discloses a roller type planetary gear for power transmission. That type of planetary gear cannot work as a clutch; since transmission of power depends on friction between the input shaft, the rollers and the outer ring, special material is required for the parts and due to wear replacement of such parts is necessary. The device according to the present invention works as a clutch, depending only on mechanical transmission. The device is, therefore, durable; and ordinary materials can be used with practically no limitation of power transmission.

U.S. Pat. No. 4,322,988 discloses a fluid braked planetary transmission. In that transmission, fluid is used as a braking medium; the structure is rather complicated and wear of the gears will result in leakage of fluid thus lowering the efficiency of the clutch. The clutch of the present invention, on the other hand, is very simple in structure, where power is transmitted only through gears and the clutch is controlled by a caliper braking on a disc.

U.S. Pat. No. 3,908,483 discloses a planetary reverse transmission in which engagement of the clutch depends on a friction plate and the structure is also rather complicated, applicable only to small motorcycles. The device of the present invention is of simple structure and is applicable to all vehicles.

EP 0 822 355 A2 discloses a continuously variable transmission having a ring gear upon which a hydro-pump acts to close a fluid loop for braking; during transmission, change in rotation speed occurs from the sun gear to the planet gears. In the present invention, there is no change in rotation speed, and braking is by means of a caliper acting on a disc; while no ring gear is required, the efficiency and reliability are also higher.

U.S. Pat. No. 4,662,245 discloses an infinitely variable transmission being of a very complicated structure and working only as a gear box. The device of the present invention is of simple structure and works efficiently as a clutch.

U.S. Pat. No. 4,369,674 discloses a power transmission device, in which engagement of the clutch is by means of a ratchet pawl and ratchet teeth; the device is complicated in structure with high precision requirements, and is mainly applied to small motorcycles only. In the constant mesh clutch of the present invention, engagement of the clutch is through a caliper braking on a disc, not only simple in structure, but also applicable to all vehicles.

### OBJECT OF THE INVENTION

One object of the present invention is to provide a constant mesh clutch designed to overcome all the above-said disadvantages.

Another object of the present invention is to provide a transmission device which is simple in structure, easy to maintain, and works with high efficiency.

A third object of the present invention is to provide a transmission device requiring neither friction plate nor diaphragm-spring, nor any braking fluid, to be applied to all kinds of motor vehicles.

### SUMMARY OF THE INVENTION

The above and other objects, as well as various advantages, of the present invention which will become apparent hereinafter, are achieved by providing a constant mesh clutch, to replace the traditional clutch of manual transmission and the torque converter of automatic transmission. The constant mesh clutch according to the present invention consists of a planetary gear, comprising a first sun gear on the input end and a second sun gear on the output end, a multiple number of planet gears in mesh with the sun gears, a planet gear carrier which holds the said planet gears and a braking device to apply a braking force on the said carrier.

The constant mesh clutch according to the present invention improves the poor efficiency of the torque converter type automatic transmission, and removes the inconvenience of time-consuming maintenance of the friction plate type manual transmission. The present device is not only simple in structure and high in efficiency, but also requires no special technology or precision of materials.

Advantageously, in a preferred embodiment, the first sun gear is connected to the flywheel of the vehicle, while the second sun gear, to the spigot input shaft of the gearbox by means of a splined hub formed in its shaft which shaft also serves to carry the first sun gear. The said braking device comprises a caliper mounted on the flywheel housing to brake upon the a disc extending from the periphery of, and formed integral with, the planet gears carrier. When the caliper does not brake on the disc, the disc is free, so that when the first sun gear on the flywheel side rotates, the planet gears will be revolving together with their carrier, resulting in that no power is transmitted from the planet gears to the second sun gear. When the caliper applies a full brake force on the disc, the latter is held tight so that the rotating planet gears will be driving the second sun gear, which in turn will drive the spigot input shaft of the gearbox. Apparently, any other types of known braking devices suitable for the present clutch can be used instead of the above-said caliper and disc, to reach the same function.

Advantageously, as seen from the above, the power transmitted from the first sun gear to the second sun gear is directly proportional to the brake force applied upon the disc from the caliper. With less (more) brake force applied upon the disc, the planet gear carrier will be rotating more slowly (quickly). This allows stepless change of the vehicle speed.

Advantageously, since the said caliper is mounted on the flywheel housing, if worn out, its friction pads can be replaced easily without the need of removing the whole gearbox, as against the conventional type device, in which replacing of a friction plate or a diaphragm-spring would require removing of the whole gearbox, thus resulting in much more efforts and time spent.

### BRIEF DESCRIPTION OF THE DRAWINGS

FIG. 1 is a Front Elevation View of the constant mesh clutch according to the present invention; and

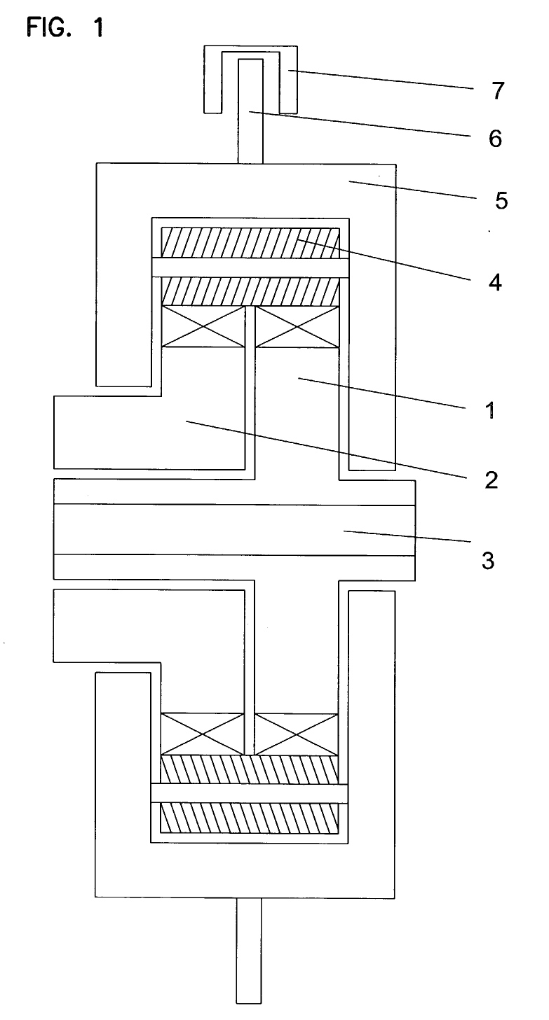

FIG. 2 is a Side Elevation View of the constant mesh clutch according to the present invention.

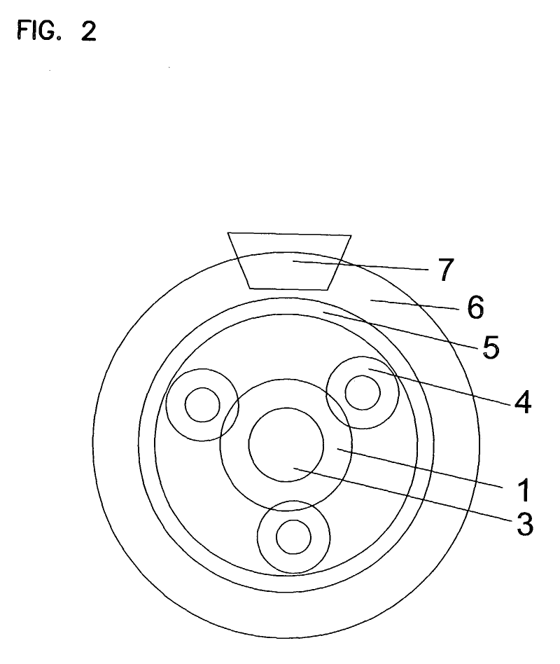

### DETAILED DESCRIPTION OF THE PREFERRED EMBODIMENT

A constant mesh clutch, as shown in the drawings, comprises a first sun gear 2 connecting to the flywheel of the vehicle, a second sun gear 1 connecting to the spigot input shaft of the gearbox by means of a splined hub 3 formed in its shaft which also serves to carry the first sun gear 2, a number of planet gears 4 in mesh with the said two sun gears 1 and 2 and held by a planet gear carrier 5. Formed integral with and extending radially from the middle of the outer periphery of the said planet gear carrier 5 is a disc 6, which is controlled by a caliper 7. When a different hydraulic pressure is applied to the said caliper 7, a different brake force is applied by it upon the disc 6, so that the disc 6 is either held tight, or released, or capable of rotating at different speeds.

Now, when the disc 6 is released and can rotate freely, the input power from the sun gear 2 cannot be transmitted to the sun gear 1, because the planet gears 4 will be revolving together with the planet gear carrier 5. On the other hand, if the disc 6 is held tight and cannot rotate, the input power will be fully transmitted to the sun gear 1 through the planet gears 4; so the gearbox will be set in work.

As said, a different hydraulic pressure results in a different brake force applied upon the said disc 6, leading to a different input power being transmitted to the gearbox. So the power transmitted from the input side to the output side is directly proportional to the brake force applied upon the disc 6. The vehicle can thus be driven at different speeds.

In a torque converter type automatic transmission, power is transmitted hydraulically from the engine to the impellor and the turbine is driven by hydraulic fluid, which results in a very complicated structure and has the disadvantage of having a low efficiency. The traditional manual clutch, on the other hand, works on a driven plate and depends on a diaphragm spring clutch for transmission of power from the engine to the gearbox; however, when the friction plate wears out and the diaphragm spring is no longer good due to material fatigue, replacement of such parts is very troublesome whereby the gearbox has to be removed; and after replacement of the parts adjustment is necessary.

The constant mesh clutch according to the present invention is free from the above said disadvantages. It is easy to maintain and requires no special technology, while an efficient stepless transmission of power is realized.

Though the present invention was shown and described with reference to the preferred embodiment, that is merely illustrative of the main idea of the present invention, and is not to be construed as a limitation thereof. Various modifications are certainly possible with those skilled in the art. It is, therefore, not intended to limit the present invention to the disclosed embodiment or the details thereof, and the present invention should include all variations and/or alternative embodiments within the spirit and scope of the present invention as defined by the appended claims.

What is claimed is:

1. A constant mesh clutch for transmitting a rotational movement between an input and an output, wherein:
a first sun gear is comprised on the input side,
and a second sun gear, on the output side;
and a number of planet gears, held in a planet gears carrier, are in mesh with the said sun gears;
in addition, there is also provided a braking device to apply a braking force upon the said planet gears carrier.

2. A constant mesh clutch as claimed in claim 1, wherein said braking device comprises a disc, extending radially from the periphery of, and formed integral with, said planet gears carrier, and a caliper is provided to apply a braking force upon said disc.

3. A constant mesh clutch as claimed in claim 1, wherein said second sun gear is provided with a shaft formed integral with it, and also serving to carry said first sun gear.

4. A constant mesh clutch as claimed in claims 1 or 3, wherein said sun gear 2 is connected to a flywheel of the vehicle; and said sun gear 1 is connected to a spigot input shaft of the vehicle's gearbox by means of a splined hub formed in its shaft.

5. A constant mesh clutch as claimed in claim 2, wherein said caliper is controlled by hydraulic pressure to apply different braking forces upon said disc.

6. A constant mesh clutch as claimed in claim 2, wherein said caliper is mounted on the flywheel housing of the vehicle.

7. A constant mesh clutch as claimed in claim 2, wherein said caliper is provided with friction pads for the purpose of braking upon said disc.

8. A constant mesh clutch as claimed in claim 1 wherein said planet gears total three.
